(19) United States
(12) Patent Application Publication
(10) Pub. No.: US 2003/0132607 A1
(43) Pub. Date: Jul. 17, 2003

(54) Safe automobile towing structure

(76) Inventor: Hsin-Yuan Pan, Taipei City (TW)

Correspondence Address: One Skyline Plac 5205, Suite 1404, Leesburg Pike, falls Church, VA, 22041, US

(21) Appl. No.: 10/042,224

(22) Filed: Jan. 11, 2002

(51) Int. Cl. B60D 1/00

(52) U.S. Cl. 280/491.5; 280/491.1

(57) ABSTRACT

The present invention relates to a safe automobile towing structure, which contains a connecting rod with a flashing alarm at each side. On each end of the connecting rod is an extension rod, which end is installed with a rotational base. At the connection, the rotational base and the extension rod are mutually installed with a rotational axle. The rotational path between the rotational base and the extension rod is installed with corresponding bumpers. An adjusting rod is installed at the end of the rotational base. At the connection, the adjusting rod and the rotational base are mutually installed with a revolving axle that is perpendicular to the rotational axle. Besides, the vertically rotational path is installed with corresponding bumpers. The end of the adjusting rod is installed with a steel rope base.

### BACKGROUND OF THE INVENTION

1. Field of the Invention

The present invention relates to a safe automobile towing structure, which especially means a new structural design that can be dissembled for easy carriage when it is not used and assembled by a DIY (Do It Yourself) method to be an integrated object with stability provided for towing and warning given to surrounding people and cars to assure every aspect of the safety.

2. Description of the Prior Art

A car breakdown event is a headache but also an inevitable thing. Especially because of large size, heavy weight and the technical skills involved, most time ordinary people can not fix the broken car by themselves. Instead, they can only move the broken car to a garage and have professionals to do the repair. Therefore, towing a broken car is a serious matter for car owners.

On the streets, people usually ask professional towing companies to handle the towing work. In this way, it is expensive and only suitable for small cars. If a car breakdown occurs to a large size car or in a remote area that no towing company is available, asking professional's help becomes impossible. Hence, presently the most popular way to tow a car is first to find a car of the same model or a car with larger size, followed by tie a steel rope between the two cars, so the normal car can tow the broken car by the steel rope. However, because the towing tool is a steel rope, some of the following accidents may happen.

1. Because of the elastic force generated by the steel rope when the front car is pulling the rear car, the rear car may not react to move simultaneously and causes a collision with the front car by a sudden forward rush.

2. Similarly, when the front car suddenly stops, the rear car will rush forward and hit the front car.

3. When the steel rope is overloaded, it won't break immediately, which misleads the driver to think the rope works well. As the car is still moving, a sudden breakage of the steel rope can make the car out of control and result in danger.

4. The steel rope swings when the car is moving. Besides, when the front car is making a turn, the movement of the rear car is hard to control. These add difficulties to towing a car.

In addition, most people do not display the warning signs when they are towing a car. Pedestrians or other cars may approach without careful attention. Further, the swinging of the towed car may cause accidents by colliding with other cars.

The inventor for the present invention has been involved in car maintenance for several decades, during which he has seen many tragedies caused by the above-mentioned accidents. Therefore, the inventor is dedicated to the investigation of various shortcomings found in the traditional car towing structure and eagerly seeks improvements and innovations. Further, the inventor successfully accomplishes a safe automobile towing structure in the present invention.

### SUMMARY OF THE INVENTION

The objective of the present invention is to provide a safe automobile towing structure that uses a hard rod to connect the front car and the rear car. No matter how the front car moves, the stability of the broken car can be maintained and road safety is assured.

Another objective of the present invention is to provide a safe automobile towing structure, wherein a horizontal or vertical revolving axle is installed at each connecting end, which functions well even for a large turn; besides, a restriction is put on the turning angle, so it will not be too large to affect the car movement.

Another objective of the present invention is to provide a safe automobile towing structure, wherein a flashing alarm giving off light and sound is installed to warn other people or cars to keep in a distance and prevent accidents caused by poor visibility or carelessness.

Another objective of the present invention is to provide a safe automobile towing structure, which is assembled in a DIY way so the dissembled parts can be stored in a holding box with minimized space and ease of immediate use.

### BRIEF DESCRIPTION OF THE DRAWINGS

The drawings disclose an illustrative embodiment of the present invention, which serves to exemplify the various advantages and objects hereof, and are as follows:

FIG. 1 is the three-dimensional disassembled diagram for the present invention;

FIG. 2 is the three-dimensional assembled diagram for the present invention;

FIG. 3 is the illustrative example of the holding box for the present invention;

FIG. 4A and FIG. 4B are the illustrative examples of using the steel rope base for the present invention;

FIG. 5A˜FIG. 5D are illustrative diagrams for four different towing coupling mechanisms

FIG. 6A is a cutaway view for the connecting plane between the rotating base and the adjusting rod;

FIG. 6B is a three-dimensional view for the connecting plane between the rotating base and the adjusting rod;

FIG. 6C is an illustrative diagram that shows the movement of the thorn teeth and the buckling block for the present invention;

FIG. 7 is the illustrative diagram for the flashing alarm that gives light and sound in the present invention;

FIG. 8 is the illustrative diagram for the elastic orientation adjusting base in the present invention; and

FIG. 9 is the operation diagram for the operation rod in the present invention.

Legends for the Main Components

| | | | |
|---|---|---|---|
| 1 | Connecting rod | 10 | Holding box |
| 11 | Screw aperture | 12 | Holding tank |
| 2 | Extension rod | 20 | Coupling |
| 20a | Coupling | 20b | Coupling |
| 20c | Coupling | 20d | Coupling |
| 21 | Bolt | 3 | Rotational base |
| 4 | Adjusting rod | 41 | Screw aperture |
| 5 | Steel rope base | 51 | Bolt |
| 52 | Screw shaft | 53 | Steel rope ring |
| 54 | Fixed sleeve | 55 | Expanding sleeve |
| 551 | Screw thread | 552 | Fastener |
| 56 | Spring | 57 | Nut |
| 58 | Operation rod | 6 | Flashing alarm |
| 61 | Screw | 62 | Speaker |
| 63 | Warning light | 64 | Image sensor |
| 65 | Control switch | 71 | Rotational axle |
| 72 | Rotational axle | 73 | Axle center |
| 731 | Oilet | 732 | Oil passage |
| 74 | Revolving axle | 75 | Revolving axle |
| 76 | Thorn teeth | 77 | Buckling block |
| 771 | Spring | 772 | Groove |
| 81 | Bumper | 82 | Bumper |
| 83 | Bumper | 84 | Bumper |
| 9 | Elastic orientation- | 91 | Screw |
| | adjusting base | | |
| 92 | Top cover | 93 | Spring |
| 94 | Bottom cover | 541 | Blocking Blade |

### DETAILED DESCRIPTION OF THE PREFERRED EMBODIMENT

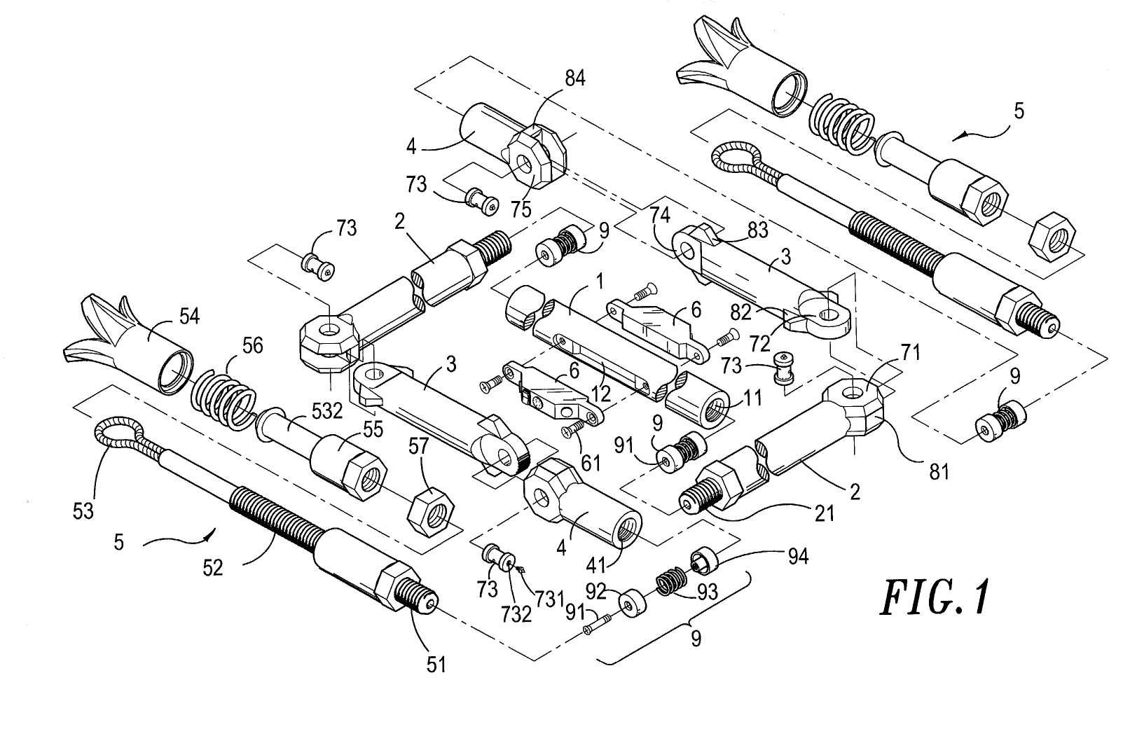

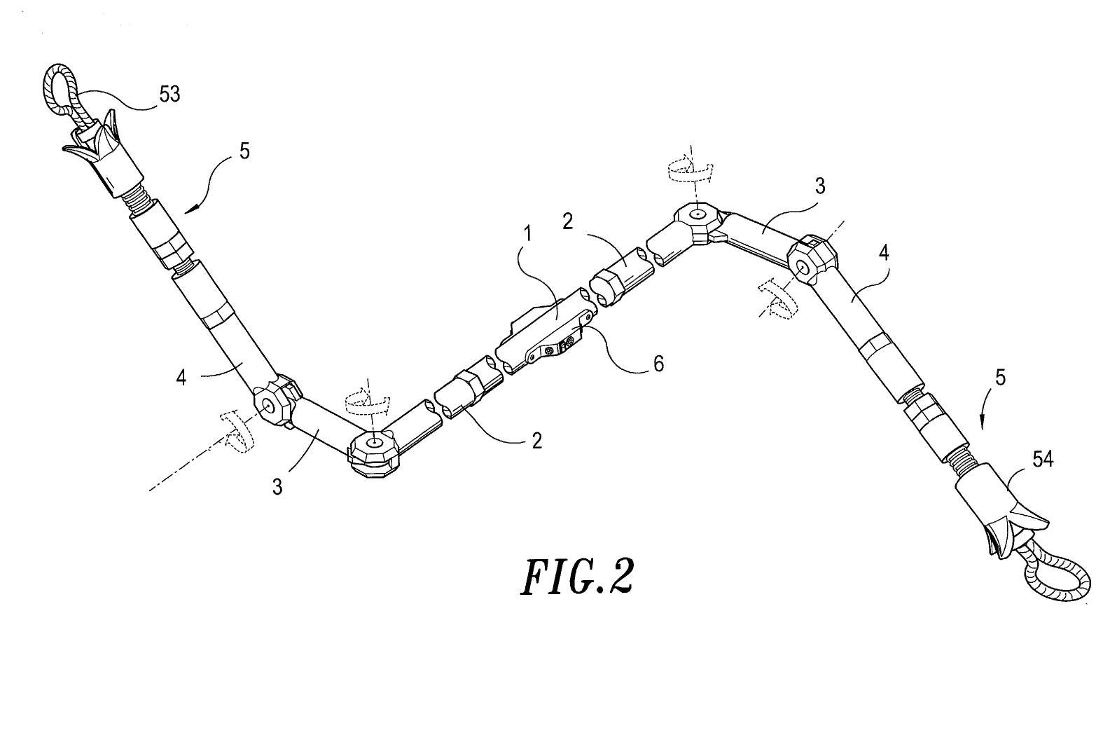

Please refer to FIG. 1 and FIG. 2 for the safe automobile towing structure provided in the present invention, which mainly includes a connecting rod 1, two extension rods 2, two rotational bases 3, two adjusting rods 4, two steel rope bases 5 and two flashing alarms 6. Wherein, the two extension rods 2, the two rotational bases 3, the two adjusting rods 4 and the two steel rod bases 5 are installed at the opposite ends of the connecting rod 1 and can be assembled or disassembled in the order as connecting rod 1, extension rod 2, rotational base 3, adjusting rod 4, steel rope rod 5. Although the two flashing alarms 6 are installed at the opposite ends of the connecting rod 1, only the description of installation at a single end is given in the following.

The connecting rod 1 is a vertical rod with screw apertures 11 at both ends. The extension rod 2 has a bolt 21 at the place corresponding to the screw aperture 11, which makes the extension rod 2 to lock in or move out of the connecting rod 1. At the connection, the extension rod 2 and the rotational base 3 are mutually installed with the rotational axles 71 and 72, inside which there is the axle center 73. So the rotational base 3 can rotate around the extension rod 2. To avoid the stress induced damage due to the relative rotation between the extension rod 2 and the rotational base 3, the rotational axle 71 can be enlarged and fringed as reinforcement. On the rotational path for the extension rod 2 and the rotational base 3, there are bumpers 81 and 82 to limit the rotating angle for the rotational base 3. At the connection, the rotational base 3 and the adjusting rod 4 are mutually installed with the revolving axles 74 and 75, inside which there is the axle center 73 to make the revolving axles 74 and 75 perpendicular to the rotational axles 71 and 72. So the adjusting rod 4 can rotate around the rotational base 3. The rotational axle 75 has the same reinforcing structure as the rotational axle 71. Besides, on the vertical rotational path for the rotational base 3 and the adjusting rod 4, there are corresponding bumpers 83 and 84 to limit the swinging angle for the adjusting rod 4. The connection between the adjusting rod 4 and the steel rod base 5 has a screw aperture 41. The steel rope base 5 has a bolt 51 corresponding to the screw aperture 41. The steel rope base 5 has a screw shaft 52 corresponding to the other end of the bolt 51. At the front end of the screw shaft 52, there is a steel rope ring sleeve 53, which rear end has a fixed sleeve 54. At the rear end of the fixed sleeve 54, there is an expanding sleeve 55, inside which there is screw teeth 551 that can rotate about the screw shaft 52. At the front end of the expanding sleeve 55, there is a fastener 552 to be connected to the fixed sleeve 54. There is also a spring 56 between the fixed sleeve 54 and the expanding sleeve 55. On the rear side of the expanding sleeve 55, there is a nut 57. The connecting rod 1 has a holding tank 12 at the position of the flashing alarms 6. The holding tank 12 complies with the shape of the flashing alarm 6 and is fastened with the screws 61. In addition, inside the screw aperture 11 and 41 for the connecting rod 1 and the adjusting rod 4 there are elastic orientation adjusting bases 9, which are fastened to the screw apertures 11 and 42 by screws 91 to make proper elastic adjustment of the rod rotational angle between the two sides of the elastic orientation adjusting bases 9.

After the completion of the above-mentioned safe automobile towing structure, the assembling proceeds with the steel rope bases 5 at both ends fastened to the couplings of the front and the rear cars. Then the towing work starts right away. When cars are making turns or changing lanes, the bumpers 81 and 82 maintain proper turning angles for the front car and the rear car. For bumping land surface, previously mentioned bumpers 83 and 84 are provided with the same structure as the bumpers 81 and 82. The bumpers 81, 82, 83 and 84 on previously mentioned extension rod 2, rotational base 3 or adjusting rod 4 are in cone shape with the exterior declined surface of 45 degree to limit the relative rotating angle for the two neighboring rods less than 90 degree. The accidental collision between the front car and the rear car can be avoided in such way so the safety is assured when the car is moving.

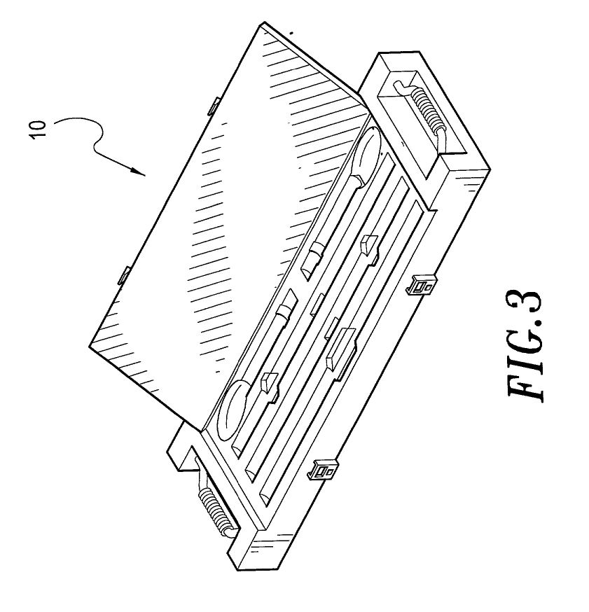

Please refer to FIG. 3 for previously mentioned assembling or disassembling in a DIY way. The disassembled parts can be stored in a holding box 10 for a systematic and space-saving classification and storage. So the holding box 10 can be easily put in the trunk or limited space for instant use.

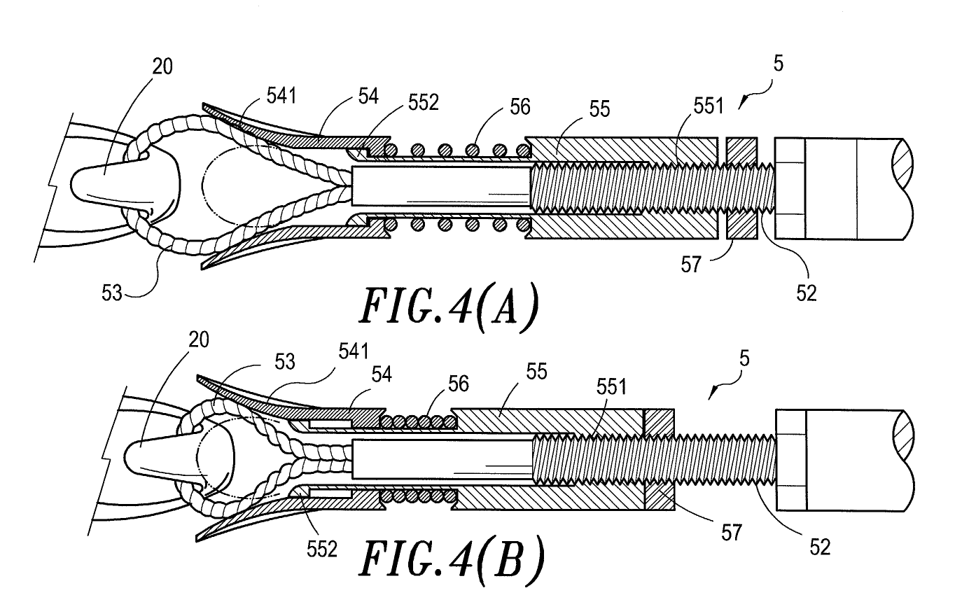

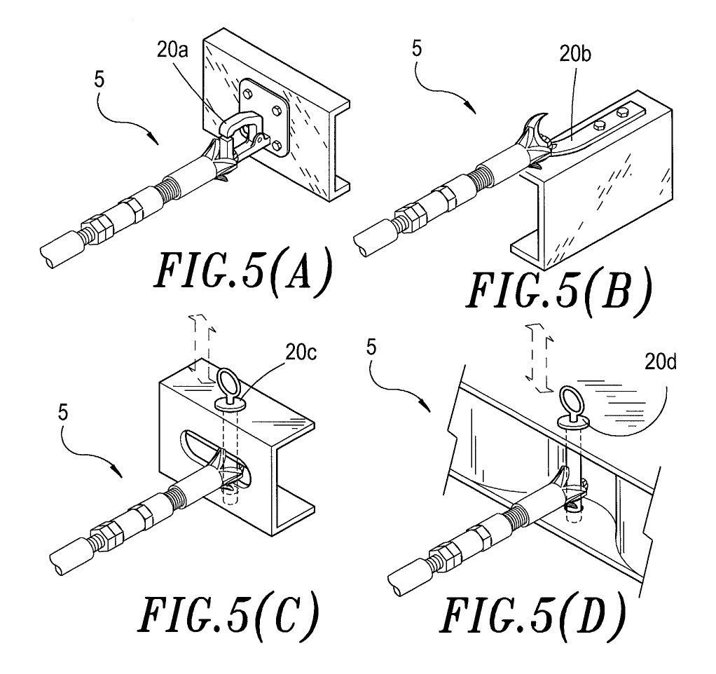

Please refer to FIG. 4A and FIG. 4B for the illustrative diagram of the steel rope base 5. First, the steel rope ring 53 is hooked up to the coupling 20. Then the expanding sleeve 55 rotates along the screw shaft 52 forward. The expanding sleeve 55 moves the fixed sleeve 54 forward by a spring 56. So the fixed sleeve 54 is pressed onto the steel rod sleeve 53 to lock the coupling 20. At this time, keeping pushing the expanding sleeve 55 can press the spring 56 to adjust the tightness of the fixed sleeve 54. Then the nut 57 is pushed to assure the tightness of the expanding sleeve 55. At the front end of previously mentioned fixed sleeve 54, there are radiating petal-shaped blocking blades 541, which appear in arc shape to avoid the damage to the steel rope ring. The steel rope base 5 is applicable to any type of coupling, such as 20a, 20b, 20c and 20d, as shown in FIG. 5A˜FIG. 5D.

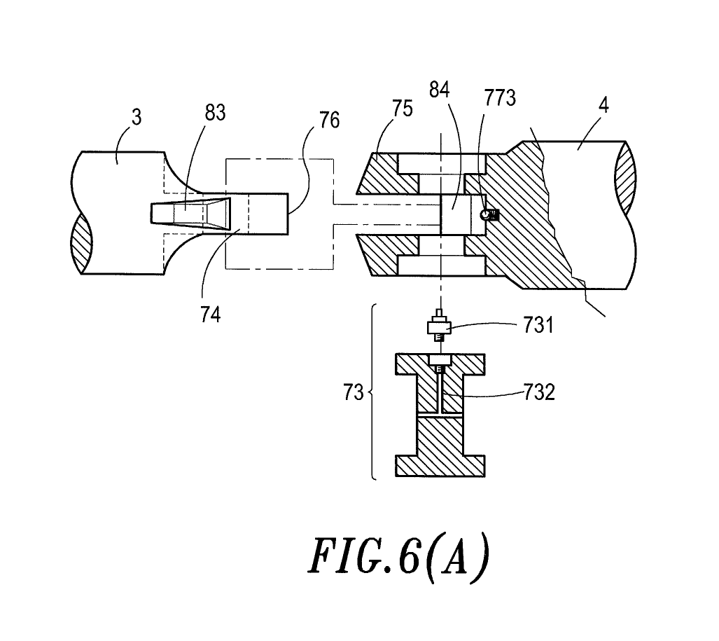

Please refer to FIG. 6A, FIG. 6B and FIG. 6C for maintaining smooth rotation when the extension rod 2 and the rotational base 3 move left and right during towing process. However, the rotational base 3 and the adjusting rod 4 swing vertically at a rather small angle. So the present invention installs thorn teeth 76 on the revolving axle 74 of the rotational base 3. Correspondingly, inside the rotational axle 75 of the adjusting rod 4, there is a cushion block 77, inside which there are several grooves 771, inside which there are several springs 772. The front of the said springs is buckling block 773. By inserting buckling block 773 into the thorn teeth 76, the rotational base 3 and the adjusting rod 4 can maintain a stable towing action under normal condition, while enhances the towing stability for a car to move on a bumping land surface by a stepwise adjustment for a proper angle. Further, an oilet 731 is installed at the exterior of previously mentioned axle center 73. At the rear end of the oilet 731, there is an oil passage 732, which can lead the lubricant into the revolving axles 71, 72, 73 and 74 to assure a smooth rotation.

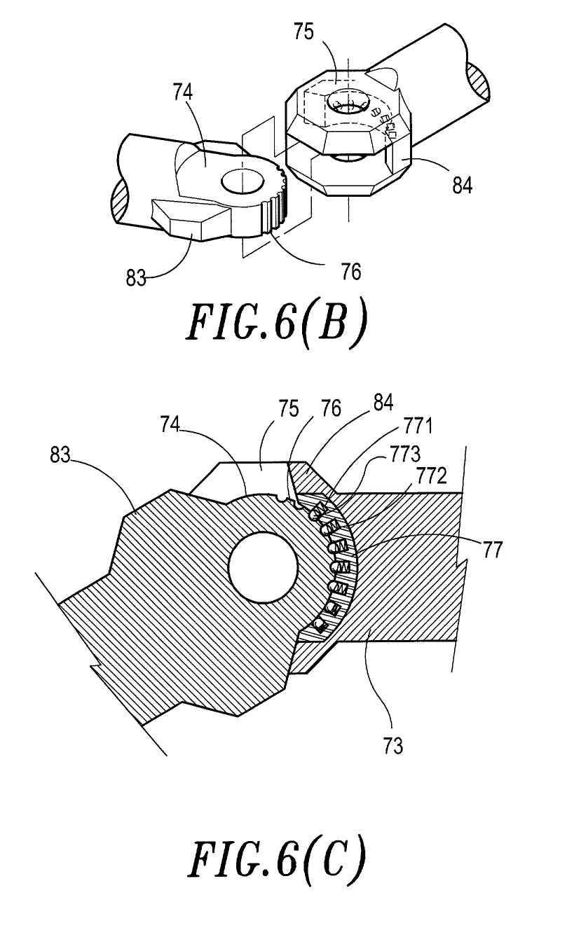

Please refer to FIG. 7 for the flashing alarm 6, which has a speaker 62, a warning light 63, an image sensor 64 and a control switch 65 and is powered by batteries. Wherein, the control switch 65 has a three-step control method as follows: the first step is to turn on the speaker 62 and the warning light 63; the second step is first to turn on the warning light 63 with simultaneous activation of the image sensor 64, followed by turning on the speakers 62 if human or cars are approaching; the second step is to activate the image sensor 64, or to turn on both the speakers 62 and the warning light 63 simultaneously to warn the approaching pedestrians or cars; the third step is to turn off the circuit. The warning light 63 can also be adjusted for its color, intensity or flashing mode. The speakers 62 can be adjusted for its volume or tone. Besides, the speakers 62 and the warning light 63 can be adjusted for their quantity.

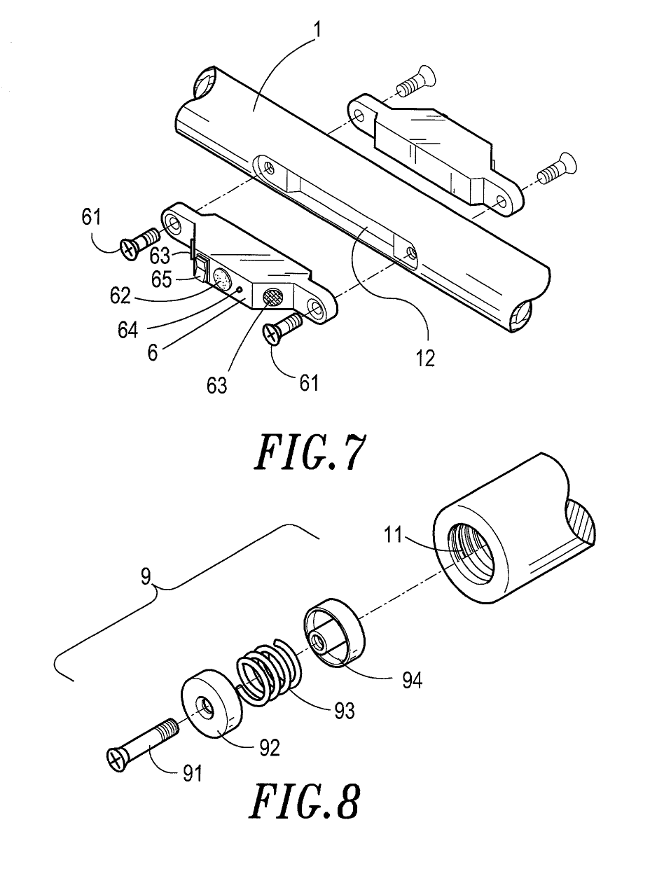

Please refer to FIG. 8 for previously mentioned adjusting base 9, which contains a top cover 92, a spring 93 and a bottom cover 94. A screw 91 is used to penetrate the top cover 92, the spring 93 and the bottom cover 94 and is fastened on the connecting rod 1 or the adjusting rod 4. The angle between the two ends of the elastic orientation-adjusting base 9 can be properly adjusted by the spring 93 even when the rod components are fastened. Thus, the flashing alarm 6 on the connecting rod 1 can be maintained on both sides of the car to provide the best warning effect without declining.

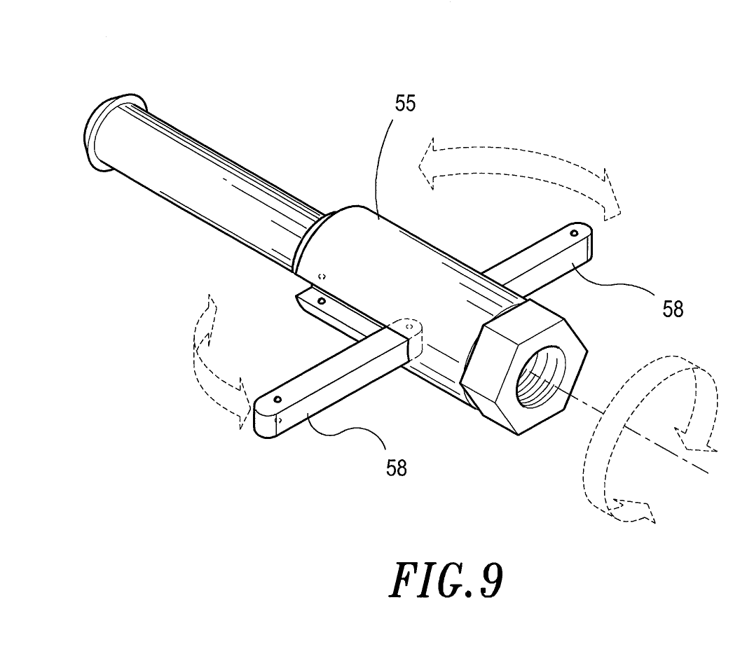

Please refer to FIG. 9. For easy operation, the expanding sleeve 55 surface of the steel rope base 5 has the operation rods 58 on opposite sides. The operation rods 58 can be folded in the expanding sleeve 55. The operation rods 58 open to both sides during use to form a wrench-like device, which can rotate the operation rods 58 along the rotational direction of the expanding sleeve 55, so the steel rope base 5 can be firmly hung to the coupling 20.

When compared to the traditional technology, the safe automobile towing structure provided in the present invention has the following advantages:

1. The present invention provides a safe towing function that a broken car can be safely towed without swinging to prevent road accidents.

2. The present invention is applicable to every kind of road condition, even at a large angle turn, without space limitation.

3. The present invention can provide warning to other people and cars to prevent them from mistakenly getting into the towing range and to minimize the accidents.

4. The present invention provides the ease of carriage and fast assembling during use, so road blockage is avoided and smooth road condition is maintained. This promotes the widespread use of the invention.

Many changes and modifications in the above-described embodiment of the invention can, of course, be carried out without departing from the scope thereof. Accordingly, to promote the progress in science and the useful arts, the invention is disclosed and is not intended to be only limited by the scope of the appended claims.

What is claimed is:

1. A safe automobile towing structure, which includes:
a connecting rod with screw apertures at both ends and a flashing alarm on each side of the connecting rod surface;
two extension rods, installed at the both ends of the connecting rod, with a bolt at the front end of each extension rod corresponding to the screw aperture of the connecting rod;
two rotational bases, installed respectively at the rear ends of the two extension rods, with rotational axles mutually installed at the connection between the front end of each revolving axle and the extension rod, fastened by an axle center, and corresponding bumpers on the rotation path for the rotational base and the extension rod so that the rotation angle is limited during rotation;
two adjusting rods, installed respectively at the rear ends of the two rotational bases, with revolving axles mutually installed at the connection between the front end of the adjusting rod and the rotational base, fastened by an axle center to be perpendicular to the rotational axle, and corresponding bumpers on the vertical rotation path for the adjusting rod and the rotational base so that the rotation angle of the adjusting rod with a screw aperture at its rear end is limited during rotation;
two steel rope bases, installed respectively at the screw apertures of the two adjusting rods, with a corresponding bolt to the screw apertures at the steel rope base, and a screw shaft corresponding to the other end of the bolt, and a steel rope ring at the front end of the screw shaft, and a fixed sleeve at the rear end of the steel rope ring, and at the rear end of the fixed sleeve a expanding sleeve of screw threads that can rotate and move along the screw shaft, and a retainer that can be fastened to the fixed sleeve, and a spring between the fixed sleeve and the expanding sleeve, and a nut at the rear of the expanding sleeve.

2. The safe automobile towing structure according to claim 1, wherein petal-shaped blocking blades are installed at the front end of the fixed sleeve of the steel rope base with arc surface on blocking blades to avoid damages to the steel rope ring.

3. The safe automobile towing structure according to claim 1, wherein the extension rod, the rotational base or the bumpers on the adjusting rods appear in cone shape with declined surface of 45 degree to limit the relative rotational angle for the two neighboring rods less than 90 degree.

4. The safe automobile towing structure according to claim 1, wherein inside the screw apertures of the connecting rod or the adjusting rod is an elastic orientation adjusting base, which contains a top cover, a spring and a bottom cover with a screw to penetrate the top cover, the spring and the bottom cover to be fastened inside the screw apertures, so the rotational angle between the rods at the two ends of the elastic orientation adjusting base can be adjusted by the spring.

5. The safe automobile towing structure according to claim 1, wherein outside the axle center of the revolving axle or the rotational axle is an oilet, which has oil passage at the rear end to provide the revolving axle or the rotational axle with lubrication.

6. The safe automobile towing structure according to the claim 1, wherein a holding box is installed to store all disassembled parts in order for providing convenience during carriage and use.

7. The safe automobile towing structure according to the claim 1, wherein at flashing alarm a holding tank is installed in accordance with the shape of the flashing alarm that is fasten onto the connecting rod by a screw, and the said flashing alarm contains a speaker, a warning light, a image sensor and a control switch that are powered by batteries, and the said control switch is used to activate other components, and the said image sensor is used to detect the image of humans and cars to control the action of the speaker and the said warning light that can have predetermined quantity, types and display mode as necessary.

8. The safe automobile towing structure according to claim 1, wherein on the revolving axle of the rotational base are the thorn teeth, and correspondingly, inside the rotational axle of the adjusting rod there are cushion blocks, inside which there are several grooves, wherein there are springs, which have buckling blocks ahead; and a multiple number of grooves exist at the inner side of the revolving axle of the adjusting rod that has a spring in each of the groove, and a buckling block is pressed onto the top of each spring so it can be inserted in the thorn teeth to generate stepwise movement.

9. The safe automobile towing structure according to the claim 1, wherein on the opposite two sides of the expanding sleeve of the steel rope base are the operation rods, which can be folded in the expanding sleeve and open to both sides during use in rotation with the turning direction of the expanding sleeve.

10. The safe automobile towing structure according to claim 1, characterized in that its rotational axles may be enlarged, or the rotational axle or the revolving axle may be fringed as reinforcement.
